(19) United States
(12) Patent Application Publication
(10) Pub. No.: US 2013/0044258 A1
(43) Pub. Date: Feb. 21, 2013

(54) Method for presenting video content on a hand-held electronic device

(71) Applicant: Danfung Dennis, Brooklyn, NY (US)

(72) Inventor: Danfung Dennis, Brooklyn, NY (US)

(21) Appl. No.: 13/317,342

(22) Filed: Oct. 17, 2011

Related U.S. Application Data
(60) Provisional application No. 61/575,037, filed on Aug. 15, 2011.

(51) Int. Cl. H04N 7/01

(52) U.S. Cl. 348/445; 348/E07.003

(57) ABSTRACT

A method of opening productive formations by slot-perforating, includes providing a working fluid which contains water, and abrasive component, and an additive; supplying the working fluid at a high pressure towards a formation so as to cut slots and to provide an inflow of oil, gas or hydro-geological liquid from the formation into a borehole; and using as the additive-ethylene glycol so as to reduce density of the working fluid and therefore to increase a speed of jet of the working fluid due to increase of kinetic energy of particles of the abrasive component.

### CROSS-REFERENCE TO RELATED APPLICATIONS

This application claims benefit and priority under 35 U.S.C. §119(e) from provisional application No. 61/575,037, filed on Aug. 15, 2011, the entire content of which is incorporated by reference herein.

### BACKGROUND OF THE INVENTION

The present invention relates to a method for capturing video content using a wide angle hemispheric lens, processing and presenting the processed video content on a display of a hand-held electronic tablet (e.g., an iPAD™ or iPAD2™) to enable viewers to modify a FOV within the viewed content that conveys a feeling of being immersed therein.

Digital SLRs with video capability include Canon's the EOS-1D Mark IV, EOS 5D Mark II, EOS 7D, and the newly-introduced EOS 60D. These cameras comprise large imaging sensors which are comparable to or even larger than 35 mm motion picture film. They produce high definition mimic film via their control over depth of field resulting in extremely sharp detail, clarity, and low-light performance. When used with a full-frame fisheye lens, these cameras provide a definite curved look to straight lines as a function of their inherent pronounced barrel distortion. In photography, a fisheye lens is a wide-angle lens that takes in a broad, panoramic and hemispherical image. A fisheye or wide-angle lens covers the entire frame, corner to corner, with a diagonal angle of view of 180 degrees.

The Canon's EOS SLRs utilize the H.264/MPEG-4 compression method for recording video files to the memory card in order to realize relatively compact file sizes with image quality noticeably superior to alternate video compressions (such as Motion JPEG). But such utility does come with a price. The H.264 compression format requires transcoding into an editing format, e.g., Apple's ProRes422HQ format for editing, effects, and color grading. Apple Final Cut Studio™ software enables non-linear editing (NLE).

With respect to playback, technological innovations in mobile tablet electronic devices are realizing ever more sophisticated ways of presenting video content (including audio). For example, the iPAD 2™ by Apple Computer is a hand-held electronic device that supports a number of video formats including the aforementioned H.264 format. The iPad will play video up to 1280×720p resolution, 30 frames per second in H.264 and Motion JPEG (M-JPEG) with AAC-LC audio up to 160 Kbps, 48 kHz. It will also play MPEG-4 video up to 640 by 480 pixels.

Apple's iPad 2™ provides a multi-touch touch screen, headset controls, proximity and ambient light sensors, 3-axis gyroscope, microphone, magnetometer and accelerometer. An accelerometer provides for direct measurement of orientation, while a gyro provides for a direct measurement of the time rate of change of orientation. Combining the output of these two sensors (sensor fusion) enables users to determine the orientation of the device precisely. Apple's iPAD 2™, therefore, is the perfect platform for the invention described in detail hereinbelow.

### SUMMARY OF THE INVENTION

Accordingly, it is an object of the present invention to provide a new method and system for creating and showing video content captured using an ultrawide lens (e.g., the Sigma 4.5 mm on a Canon EOS 5D, or 60D), on a mobile tablet electronic device, e.g., an Apple iPAD,™ iPAD 2™ or like electronic pad or device (see FIG. 1).

The invention provides a method of creating video content to be shown on a mobile tablet by use of an application program, i.e., the C1 application. The method includes shooting moving scenes located in front of a digital SLR camera using a fisheye lens. The fisheye lens provides the captured image data within a substantially convex semi-spherical field of view in a video file (i.e., .mov). The method includes converting the .mov file to an editing format, i.e., converting the captured data in its convex, spherical perspective to rectilinear format. The data are then edited and arranged in such a way that when reformatted (according to the QuickTime or Compressor specification) and played on a tablet using the application program (or C1 application), they are presented as if projected on a spherical inner concave surface.

That is, the final video (movie) is presented by the C1 application as a concave spherical projection, i.e., as a file by which moving scenes are shown as projected on a virtual, substantially concave semi-spherical surface. When presented on an electronic tablet, a frame of the moving data is presented, which is a subset of the entire video frame (“frame within a frame”). Using available control mechanisms, the frame within the frame may be panned vertically and horizontally to see parts of the captured image outside the traditional view frame.

When implemented in the iPAD 2™, the C1 application enables the user to control this panning by use of the hand motions to affect the gyro and accelerometer. The application program is responsive to signals generated in response to gyro and accelerometer sensed movement. Hence, in response to turning of the mobile tablet electronic device, the scenes of the virtual film move on a screen of the mobile tablet electronic device (panning). This provides a sense to the viewer that he or she is located in a focal point of the concave semi-spherical surface and is able to observe the scenes not from the front, but from various perspectives from any point in content captured wide angle convex (fisheye) lens.

In an embodiment, the invention provides a method of displaying streaming video on an electronic tablet in a way that realizes an immersive viewing experience. The method includes downloading an edited moving video file in a compressed format comprising a set of pixel data representative of a subject area field of view (FOV) first captured as raw video data using a digital SLR camera affixed with a hemispheric lens, displaying a framed portion of the edited moving video file, said framed portion comprising a default FOV defined by a subset of the pixel data representative of the subject area FOV and in response to user input, modifying the pixel data content of the default FOV being displayed to convey an appearance of panning.

Preferably, the electronic tablet includes means for controlling a the pixel content of the default FOV in response to said user input and, wherein said user input is detected by the means for controlling to thereby modify the content of the default FOV, e.g., an accelerometer, a three-axis gyroscope, a touch input device, a mouse-like input device and keyboard. The user input includes various movements mimicking panning and/or titling in any azimuth and elevational direction to change an attitude of the electronic tablet and thereby modify a content of the default FOV. The editing includes processing each frame of the subject area FOV to an edited format that is displayed in a way that renders the default FOV as if comprising a portion of a surface of an inside of a spherical dome.

In another embodiment, the invention includes a system for creating and displaying streaming video on an electronic tablet such that a viewer of the streaming video appears immersed in a subject area within which the streaming video was captured. The system includes a digital SLR camera with an ultrawide hemispheric lens for capturing moving image data over a substantially convex semi-spherical field of view within the subject area, means for electronically converting the captured moving image data to a streaming video file and an electronic tablet configured for receiving and displaying a portion of the received streaming video file comprising a default field of view (FOV), wherein a content of said received streaming video file defined by said default FOV is modified by panning or tilting the electronic tablet.

### BRIEF DESCRIPTION OF THE DRAWING FIGURES

The present invention can best be understood in connection with the accompanying drawings. It is noted that the invention is not limited to the precise embodiments shown in drawings, in which:

FIG. 1 is a frontal view of an iPad device;

FIG. 2 depicts a 4.5 mm fisheye lens;

FIG. 2C is a view of a hemisphere from above, highlighting the hemisphere outer surface (HOS);

FIG. 2B is a view of the hemisphere and HOS from the side;

FIG. 2C is a perspective view of a hollow hemisphere that highlights the inner concave surface;

FIG. 3 depicts a preferred frame center and horizontal lines within a captured subject;

FIG. 4 depicts a frame grab using a Cannon 5D dSLR with a Sigma 8 mm lens;

FIG. 5 depicts a frame grab using a Cannon 60D dSLR with a Sigma 4.5 mm lens;

FIG. 6 depicts a default rectangular frame within a circular of hemispheric field of view comprising an entirety of video content captured using a hemispheric of fisheye lens;

FIG. 7 is a flow diagram depicting the step implemented by the method of the invention; and

FIG. 8 depicts a representative computer readable medium;

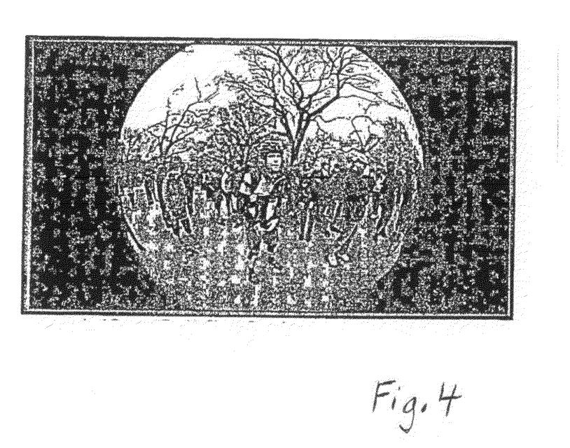

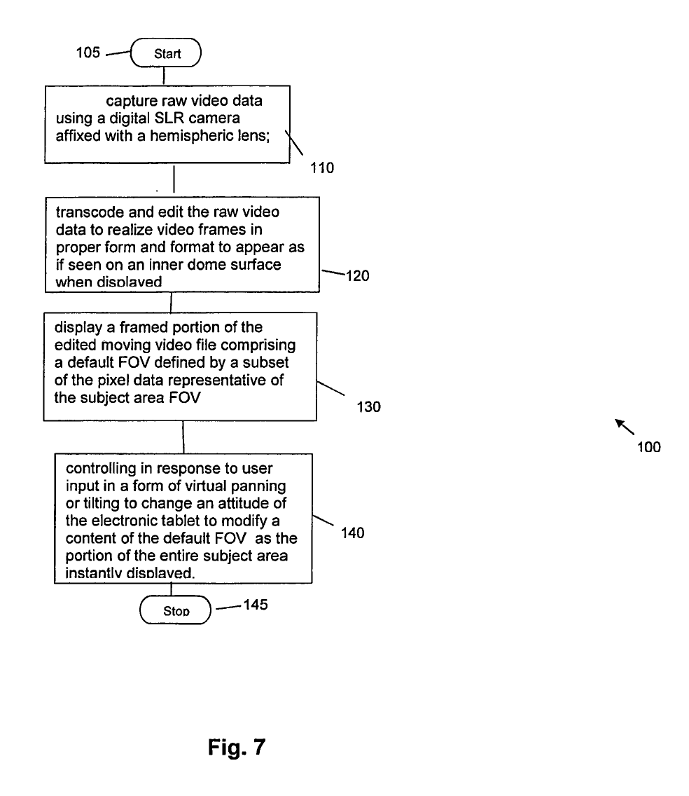

FIGS. 6 and 7 are a plan view and a side view of the mobile electronic device of FIG. 4, illustrating its operation; and

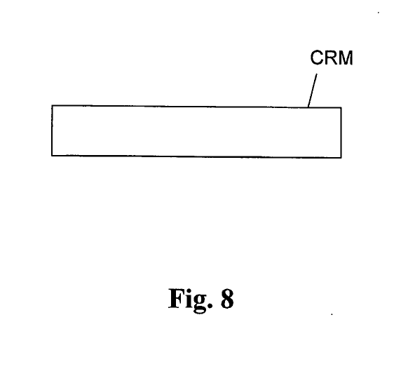

FIG. 8 is a view illustration a further embodiment of the invention.

### DETAILED DESCRIPTION OF THE INVENTION

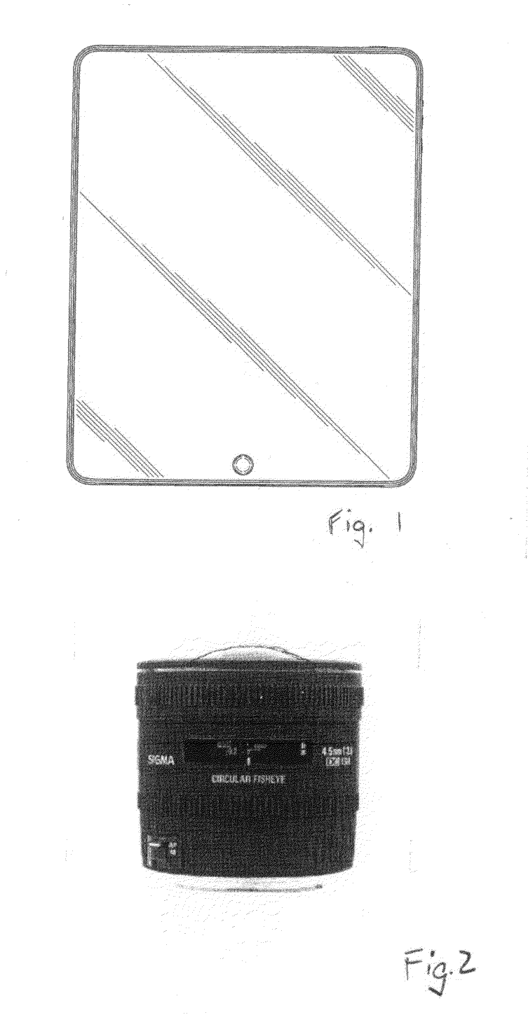

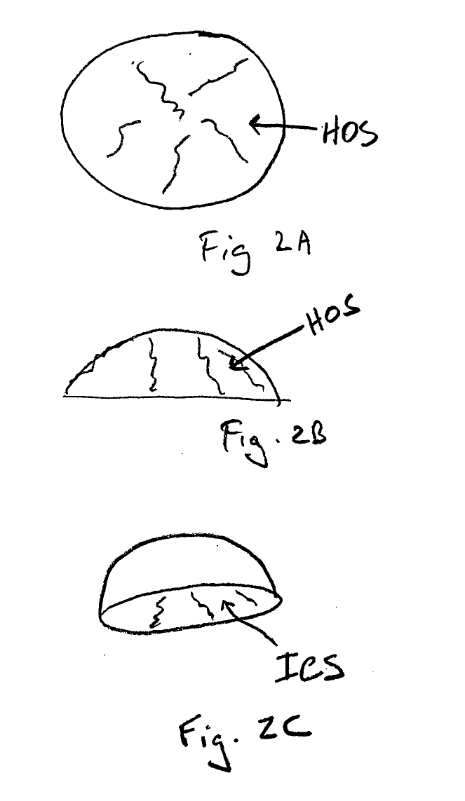

In accordance with the present invention, an ultrawide fisheye lens (e.g., 4.5 mm ultrawide lens in FIG. 2) is used to capture a full 180 degree field of view (both left-to-right and top-to-bottom). The video is recorded using high-quality a DSLR camera at full 1080/30p, filmed at different frame compositions and pacing than standard video, and edited in a way to allow the viewer to feel as if immersed in the original environment. Video captured by the wide angle (fisheye) lens is compressed using the H.264 format and decoded to a rectilinear format (for example, to Apple 422HQ files) for editing (for example, using Final Cut Pro (FCP)).

The editing process includes use of a proprietary program that operates on the rectilinear data to unwrap the data from its spherical, convex form. FIG. 2A depicts a convex hemisphere and hemispherical outer surface (HOS) from above. FIG. 2B shows a side view of the hemisphere and HOS. The proprietary editing program arranges the data in such a away that upon encoding to a movie format (for example, QuickTime), the images shown in the 2D display screen appear as if projected on an inner concave surface (ICS), such as shown I FIG. 2C. That is, once edited, the unwrapped footage is again compressed to H.264 format for playing on a tablet, i.e., iPAD™ or iPAD2™, using the inventive C1 application program. The C1 application program presents the image data in the virtual, inner concave format while allowing the viewer to move the framed field of view to pan in and explore the entire video content as it plays in the tablet's display.

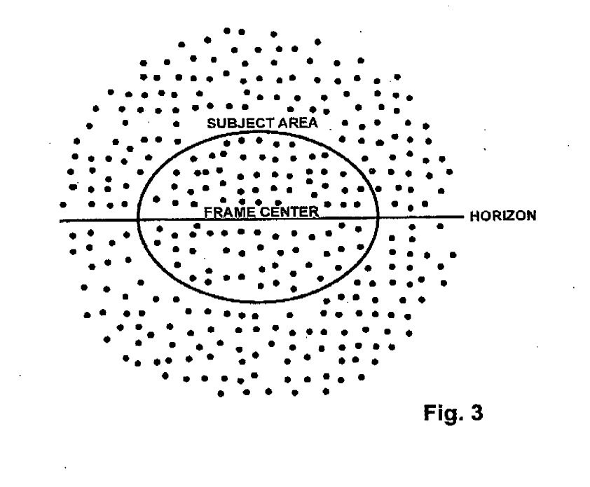

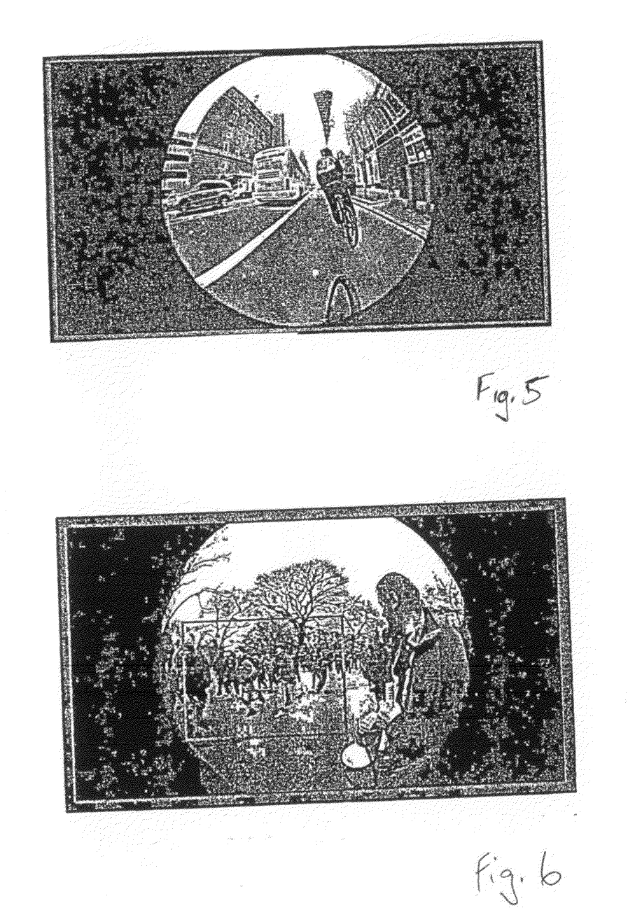

As should be apparent to the skilled videographer, it is vitally important to maintain the horizon line in the center of frame and correctly level to avoid framing issues in the final deliverable video. FIG. 3 depicts the preferred frame center and horizon line for a particular subject area to be recorded using the fisheye lens. In one exemplary set-up, the camera can be set for ISO 100, at 1/60^{th} sec., variable aperture, and if possible, 30p and HD 1920×1080 in movie mode. Using an ultrawide lens with the Canon 5D, the captured image will be circular with cropping at the top and bottom of the frame, as shown in FIG. 4. The Canon 60D will capture a full circular image with no cropping. FIG. 5 shows a frame grab with the Canon 60D using a Sigma 4.5 mm lens.

In certain frame compositions, various interesting subject matter is left outside the default field of view. The default field of view is shown in FIG. 6 as a rectangular frame within a larger circular frame. The user may “discover” by panning in certain directions, up, down, left right, as the frames of video are played at 24 to 30 frames per second. Doing so provides the user with an “immersive experience.”

As described briefly above, the camera with fisheye lens captures the full panoramic or hemispheric video in H.264 format, which is then edited on Mac desktop computer running Apple's Final Cut Pro. To do so, the captured H.264 formatted video data is first converted, or transcoded to Apple's ProRes422HQ file format. Once in 422HQ, Adobe After Effects with a FullDome Plugin by the Navegar Foundation is used, in cooperation with inventive code, to transform the video from its inherent circular (convex) form to an equi-rectangular form to be operated upon by the application program.

That is, after editing using Adobe After Effects, the equi-rectangular footage is again transcoded to H.264 format so it can play on the iPad inside the C1 application. The C1 application essentially “maps” the movie file (as it is being played) so that while presented on a 2D display screen, it nevertheless appears as if being seen on an inner surface of a dome. The C1 application uses the iPAD™ or iPad 2™ three-axis gyroscope and accelerometer sensors to track the device attitude and the user movements of same in order to control the footage, i.e., the panning outside of the default field of view.

In accordance with a further embodiment, shooting of the moving scenes can be also performed by an additional camera located behind the moving scenes, so that the produced film covers a field of view from behind over a substantially convex semi-spherical surface or a part of it. This video content is subsequently converted as described above, and edited for playing using the C1 application program. That is, both sets of data are shown on the iPAD™ or iPad 2™

When the data are converted from the ProRes422HQ format back to H.264 format, and played using the C1 application, they video appears to be projected on a virtual, substantially concave semi-spherical surface, or a parts of it. Again, this rendition or presentation provides the viewer with a virtual perspective FOV as if he or she is immersed in the place where the video is first captured. And when the tablet is turned in various directions, the change of attitude is sensed in response to which the field of view of the frame within a frame changes. Depending on how the tablet device is moved, there if a commensurate movement of the FOV of the frame. In other words, the default field of view presents a new certain subset of the composite video content as if the viewer were holding and panning the camera itself to investigates a subject area, rather than the electronic tablet during playback.

FIG. 7 depicts a flowchart for implementing the invention in one form. In a first step described in text box 110, the method includes capturing raw video data using a digital SLR camera affixed with a hemispheric lens. In a step represented by box 120, the method includes transcoding and editing the raw video data to realize video frames in proper form and format to appear as if seen on an inner dome surface when displayed. In a step represented by box 130, the method includes displaying a framed portion of the edited moving video file comprising a default FOV defined by a subset of the pixel data representative of the subject area FOV.In a step represented by box 140, the method includes controlling in response to user input in a form of virtual panning or tilting to change an attitude of the electronic tablet to modify a content of the default FOV as the portion of the entire subject area instantly displayed.

The C1 application interacts with the operating system of the electronic tablet, essentially at a tablets application program interface to allow the C1 application to respond to and/or manipulate both hardware and software. For example, an electronic pad's frame size is normally 1024 by 768 pixels per frame. This 786.5 thousand pixel size is typically only a subset of the entire set of pixels comprising each frame in a movie (captured using the wide angle (fisheye) lens, decoded and edited and encoded for playing using the C1 application). For example, each entire frame might comprise 1.08 megapixels. During playing, the C1 application, in response to user movements or cursor control, changes the location of the instantly viewed 786.5 kpixels (or sub frame) within each larger frame of image data (e.g., 1.08 Meg) as the sub-frame is processed to render each instantly viewed frame with the immersive experiential feel.

The above described methods and processes are intended to be implemented in a processor-controlled device (e.g., an electronic tablet such as an iPad™ or iPad 2™) as software comprising one or more application programs executable within the processor, or video processor commonly known to reside within electronic tablets. In particular, the steps of method of displaying streaming video on an electronic tablet in a way that realizes an immersive viewing experience is effected by instructions in the software that are executed by the processor. The programmable instructions may be formed as one or more code modules, each for performing one or more particular tasks.

The software may be stored in a non-transitory computer readable medium (CRM), such as shown in FIG. 8. CRM may comprise electronic storage devices for storing processor readable data including ROM, RAM, EPROM, EEPROM, a flash drive (USB), a hard disk drive, a floppy disk drive, as known to the skilled artisan. The software is loaded into the processor-controlled electronic tablets (e.g., an iPad™ or iPad 2™), from the computer readable medium (CRM), and executed by the processor.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

1. A method of displaying streaming video on an electronic tablet in a way that realizes an immersive viewing experience, comprising the steps of:
downloading an edited moving video file in a compressed format comprising a set of pixel data representative of a subject area field of view (FOV) first captured as raw video data using a digital SLR camera affixed with a hemispheric lens;
displaying a framed portion of the edited moving video file, said framed portion comprising a default FOV defined by a subset of the pixel data representative of the subject area FOV; and
in response to user input, modifying the pixel data content of the default FOV being displayed to convey an appearance of panning.

2. The method as set forth in claim 1, further including providing in the electronic tablet means for controlling a the pixel content of the default FOV in response to said user input and detecting said user input by the means for controlling to thereby modify the content of the default FOV.

3. The method as set forth in claim 2, further including providing in the means for controlling at least one of an accelerometer, a three-axis gyroscope, a touch input device, a mouse-like input device and keyboard.

4. The method as set forth in claim 3, further including responding by the means for controlling to said user input as various movements mimicking panning and/or titling in any azimuth and elevational direction to change an attitude of the electronic tablet and thereby modify a content of the default FOV.

5. The method as set forth in claim 1, further including utilizing a digital SLR camera to which the hemispheric lens is affixed to capture and compress video content comprising the subject area FOV, pre-editing.

6. The method as set forth in claim 5, further including transcoding the compressed video content from a circular to an equi-rectangular projection for editing.

7. The method as set forth in claim 6, further including implementing the transcoding of the compressed video content from a circular to an equirectangular projection for editing using a FullDome™ plugin.

8. The method as set forth in claim 6, further including editing to generate a ProRes422HQ movie file format.

9. The method as set forth in claim 6, further including in the editing, processing each frame of the subject area FOV to an edited format that is displayed in a way that renders the default FOV as if comprising a portion of a surface of an inside of a spherical dome.

10. The method as set forth in claim 8, further including after editing, compressing the edited equi-rectangular projection data in movie file format to an H.264 format that upon unwrapping during playing appear as if projected onto an inner surface of a portion of a concave sphere.

11. The method as set forth in claim 1, further including using a Canon 5D or 60D as the camera and 4.5 mm fisheye lens as the lens.

12. A non-transitory computer-readable medium storing a series of computer readable programmable instructions configured for execution by at least one processor for performing a method of displaying streaming video on an electronic tablet in a way that realizes an immersive viewing experience, said method comprising the steps of:
downloading an edited moving video file in a compressed format comprising a set of pixel data representative of a subject area field of view (FOV) first captured as raw video data using a digital SLR camera affixed with a hemispheric lens;
displaying a framed portion of the edited moving video file, said framed portion comprising a default FOV defined by a subset of the pixel data representative of the subject area FOV; and
in response to user input, modifying the pixel data content of the default FOV being displayed to convey an appearance of panning

13. A system for creating and displaying streaming video on an electronic tablet such that a viewer of the streaming video appears immersed in a subject area within which the streaming video was captured, comprising
a digital SLR camera with an ultrawide hemispheric lens for capturing moving image data over a substantially convex semi-spherical field of view within the subject area;
means for electronically converting the captured moving image data to a streaming video file; and
an electronic tablet configured for receiving and displaying a portion of the received streaming video file comprising a default field of view (FOV), wherein a content of said received streaming video file defined by said default FOV is modified by panning or tilting the electronic tablet.

14. The system as set forth in claim 13, wherein said electronic tablet comprises a processor, a gyroscope and an accelerometer and wherein at least one of said gyroscope and said accelerometer respond to said panning or tilting by generating signals utilized by said processor to control a content of said streaming video displayed in said default FOV.

15. The system as set forth in claim 15, wherein scenes corresponding to said default FOV are seen by a viewer as if he or she is located in a focal point of a substantially concave semi-spherical surface.

16. The system as set forth in claim 14, wherein said electronic tablet comprises an Apple iPAD,™ iPAD 2™ or like electronic pad or device.

17. The system as set forth in claim 14, wherein the means for electronically converting the captured moving image data to a streaming video file include means for editing the moving image data so that it can be displayed in the electronic tablet as if the display screen were an inner surface of a dome-like object.

18. An electronic tablet comprising means for receiving and displaying a portion of a streaming video file comprising a default field of view (FOV) formatted to appear as if projected on an inner surface portion of a hemispheric shell, the streaming video file electronically converted from streaming image data captured by a digital SLR camera with an ultrawide hemispheric lens in a substantially convex, semi-spherical field of view (FOV), and means for modifying the default FOV within the streaming video file by panning or tilting the electronic tablet.
